(19) United States
(12) Patent Application Publication
(10) Pub. No.: US 2021/0131384 A1
(43) Pub. Date: May 6, 2021

(54) Evaporated Fuel Processing Device

(71) Applicant: AISAN KOGYO KABUSHIKI KAISHA, Obu-shi (JP)

(72) Inventor: Toshiki TSUBOI, Nagoya-shi (JP)

(73) Assignee: AISAN KOGYO KABUSHIKI KAISHA, Obu-shi (JP)

(21) Appl. No.: 17/083,866

(22) Filed: Oct. 29, 2020

(30) Foreign Application Priority Data
Nov. 5, 2019 (JP) 2019-200569

(51) Int. Cl. F02M 25/08; B60K 15/035

(52) U.S. Cl. CPC F02M 25/0854; F02M 2025/0863; B60K 2015/03514; B60K 15/03504

(57) ABSTRACT

An evaporated fuel processing device includes a casing and a protector. The casing and the protector are coupled to each other via a plurality of snap-fit mechanisms. The plurality of snap-fit mechanisms include engaged portions formed on one of the casing and the protector, and engaging portions formed on another of the casing and the protector. The engaging portions are configured to engage the engaged portions via elastic deformation thereof

### CROSS-REFERENCE TO RELATED APPLICATIONS

This application claims priority to a Japanese Patent Application Serial Number 2019-200569 filed Nov. 5, 2019, which is hereby incorporated herein by reference in its entirety for all purposes.

### BACKGROUND

The present disclosure relates generally to evaporated fuel processing devices. More particularly, the present disclosure relates to an evaporated fuel processing device attached to a lower surface portion of a vehicle and configured to process evaporated fuel generated in a fuel tank of the vehicle.

A known evaporated fuel processing device (canister) is taught by, for example, JP 2002-48012A. The known evaporated fuel processing device includes a casing containing adsorbent (adsorbing materials) for adsorbing and desorbing evaporated fuel, and a protector covering a lower side of the casing. The casing is screwed on the protector. Further, the protector is screwed onto side frames of a vehicle. The protector may function to protect the casing from pebbles or mud water tossed up while the vehicle is moving.

### SUMMARY

According to one aspect of the present disclosure, an evaporated fuel processing device attached to a lower surface portion of a vehicle is configured to process evaporated fuel generated in a fuel tank of the vehicle. The evaporated fuel processing device may include a casing filled with adsorbent configured to adsorb and desorb the evaporated fuel, and a protector covering a lower side of the casing. The casing and the protector are connected to each other via a plurality of snap-fit mechanisms, which include engaged portions formed on one of the casing and the protector, and engaging portions formed on the other of the casing and the protector. The engaging portions are configured to engage the engaged portions via elastic deformation thereof. The engaging portions and the engaged portions are configured to engage each other when the casing and the protector move relative to each other in one direction.

According to another aspect of the disclosure, when the casing and the protector move relative to each other in one direction, the engaged portions and the engaging portions of the plurality snap-fit mechanisms engage with each other via elastic deformation of the engaging portions. Therefore, the casing and the protector can be easily connected to each other. Further, because the casing and the protector are connected to each other using the plurality of snap-fit mechanisms, various threaded parts can be omitted, which may lead to a reduction of parts. As a result, assembly the casing and the protector can be simplified.

Other objects, features, and advantages, of the present disclosure will be readily understood after reading the following detailed description together with the accompanying drawings and the claims.

### BRIEF DESCRIPTION OF THE DRAWINGS

FIG. 1 is a front perspective view of an embodiment of a canister in accordance with the principles described herein;

FIG. 2 is a rear perspective view of the canister of FIG. 1;

FIG. 3 is a plan view of the canister of FIG. 1;

FIG. 4 is a sectional view of the canister of FIG. 1 taken along line IV-IV of FIG. 3;

FIG. 5 is an exploded front perspective view of the canister of FIG. 1;

FIG. 6 is an enlarged, partial cross-sectional view of the protector of the canister of FIG. 1 and illustrating a drainage hole of the protector;

FIG. 7 is an enlarged, partial cross-sectional view of the canister of FIG. 1 and illustrating a first snap-fit mechanism;

FIG. 8 is an enlarged, partial side view of the canister casing of FIG. 1 and illustrating a first engagement projection;

FIG. 9 is an enlarged, partial cross-sectional view of the canister of FIG. 1 and illustrating a second snap-fit mechanism;

FIG. 10 is am enlarged, partial side view of the canister casing of FIG. 1 and illustrating a second engagement projection;

FIG. 11 is an enlarged, partial cross-sectional view of the canister of FIG. 1 and illustrating a third snap-fit mechanism;

FIG. 12 is an enlarged, partial side view of the canister casing of FIG. 1 and illustrating a third engagement projection;

FIG. 13 is an enlarged, partial cross-sectional view of the canister of FIG. 1 and illustrating a fourth snap-fit mechanism;

FIG. 14 is an enlarged, partial side view of the canister casing of FIG. 1 and illustrating a fourth engagement projection;

FIG. 15 is an enlarged, partial cross-sectional view of the canister of FIG. 1 and illustrating a fifth snap-fit mechanism;

FIG. 16 is an enlarged, partial side view of the canister casing of FIG. 1 and illustrating a fifth engagement projection;

FIG. 17 is an enlarged, partial cross-sectional view of the canister of FIG. 1 and illustrating a sixth snap-fit mechanism;

FIG. 18 is an enlarged, partial side view of the canister casing of FIG. 1 and illustrating a sixth engagement projection;

FIG. 19 is a cross-sectional view of an embodiment of a canister in accordance with the principles described herein; and

FIG. 20 is a plan view of the protector of FIG. 19.

### DETAILED DESCRIPTION

As previously described, known evaporated fuel processing devices, such as the known evaporated fuel processing device (canister) disclosed in JP 2002-48012A, include a casing screwed on the protector, which is screwed to side frames of the vehicle. Such evaporated fuel processing devices may increase the number of parts because the casing is screwed on the protector. This may lead to a complicated assembling operation of the evaporated fuel processing device. Thus, there is a need in the art for an improved evaporated fuel processing device.

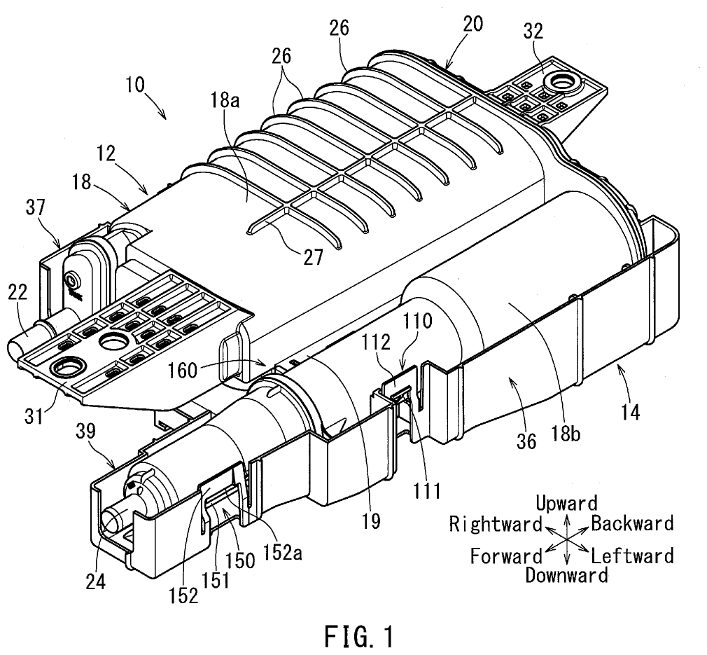

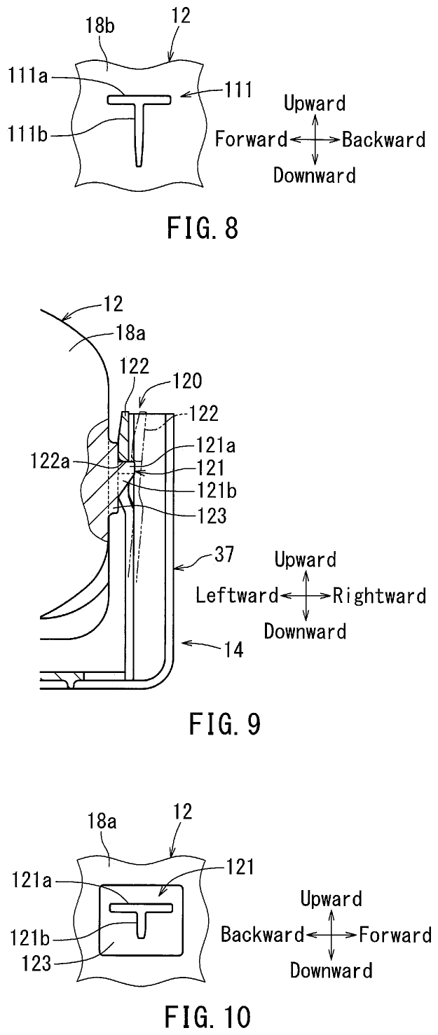

Detailed representative embodiments of the present disclosure are shown in FIG. 1 to FIG. 20.

A first representative embodiment of the present disclosure will be described with reference to FIGS. 1 to 18. As shown in FIG. 1, this embodiment is directed to an evaporated fuel processing device. In this embodiment, the evaporated fuel processing device is a canister 10 for a vehicle. Forward and backward directions, rightward and leftward directions, and upward and downward directions described with reference to the figures are shown in FIGS. 1 and correspond to forward and backward (longitudinal) directions, rightward and leftward (lateral) directions, and upward and downward (vertical) directions, respectively, of the vehicle to which the canister 10 is mounted.

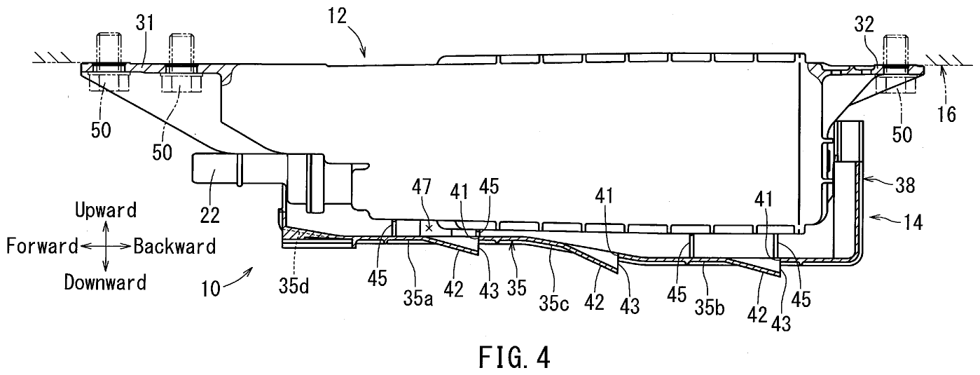

As shown in FIG. 1, the canister 10 includes a canister casing 12 and a protector 14 coupled to the canister casing 12. As shown in FIG. 4, the canister case 12 is attached to a lower surface portion of the vehicle, i.e., a lower side of a floor panel 16 of a body of the vehicle.

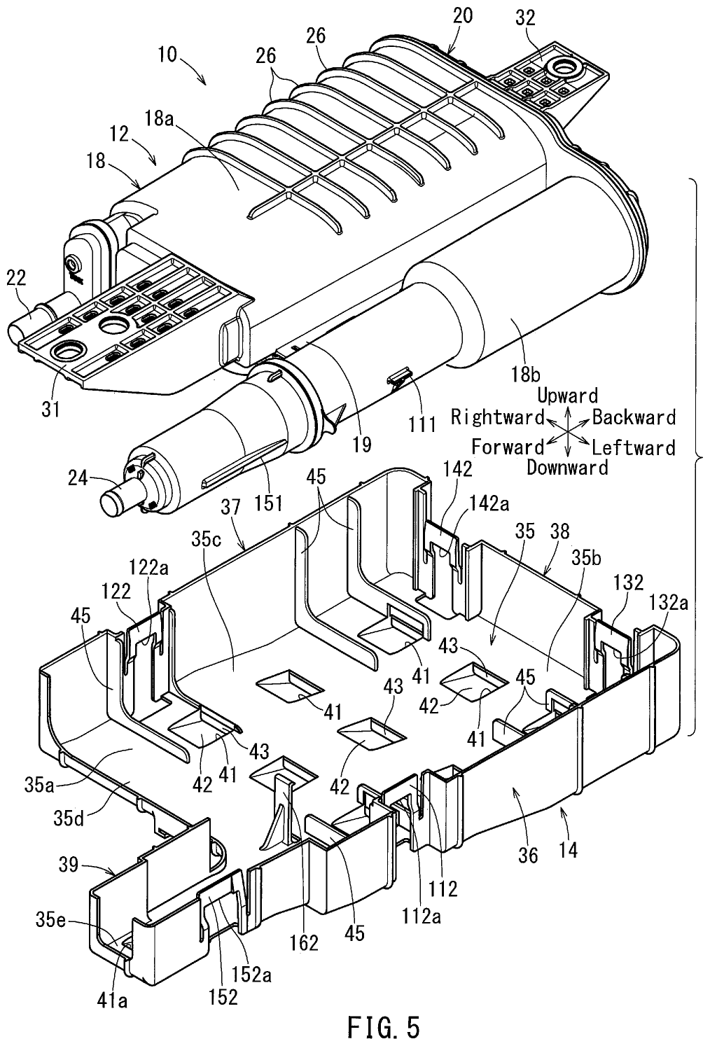

As shown in FIG. 5, the canister casing 12 includes a casing body 18 and a lid or closure plate 20 coupled to the casing body 18. The casing body 18 is composed of a main casing body 18a and a sub casing body 18b. The main casing body 18a has a flattened, hollow, rectangular, shape with rounded lateral sides, and has a length (longitudinal size) greater than a width (lateral size). The sub casing body 18b has a circular, hollow, cylindrical shape and is positioned adjacent and to the left side of the main casing body 18a. The main casing body 18a is closed at its front end and is open at its rear end. That is, the main casing body 18a has a closed front end and an open rear end. Similarly, the sub casing body 18b is closed at its front end and is open at its rear end. That is, the sub casing body 18b has a closed front end and an open rear end. Further, as shown in FIGS. 1, 3, and 5, the main casing body 18a and the sub casing body 18b are coupled laterally adjacent to each other via a longitudinally oriented, elongated flat, plate-shaped connecting member 19 that extends horizontally therebetween and is vertically centered relative to the main casing body 18a and the sub casing body 18b.

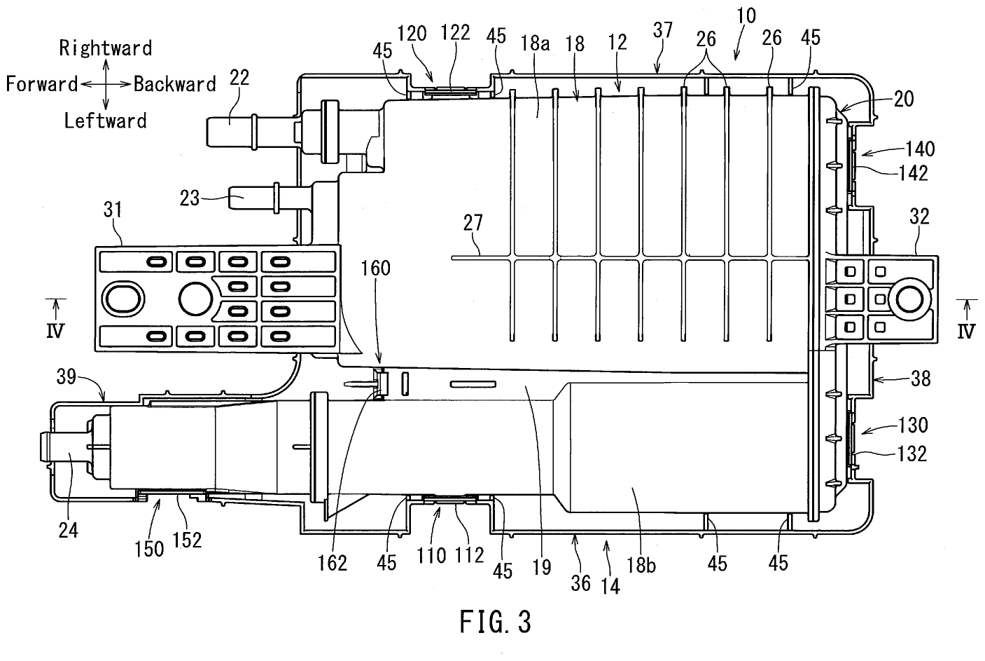

As shown in FIG. 3, the main casing body 18a has a cylindrical, tubular tank port 22 and a cylindrical, tubular purge port 23 that are in fluid communication with an interior space of the main casing body 18a. The tank port 22 and the purge port 23 are provided on a front end surface of the main casing body 18a and extend longitudinally forward therefrom. In particular, the tank port 22 is positioned on a right end portion of the front end surface of the main casing body 18a. The purge port 23 is positioned adjacent and to the left of the tank port 22.

As shown in FIG. 3, the sub casing body 18b has a frontal portion that projects longitudinally forward beyond the front end surface of the main casing body 18a. Further, the sub casing body 18b has a cylindrical, tubular atmosphere port 24 that is in fluid communication with an interior space of the sub casing body 18b. The atmosphere port 24 is provided a front end surface of the sub casing body 18b and extends longitudinally forward therefrom.

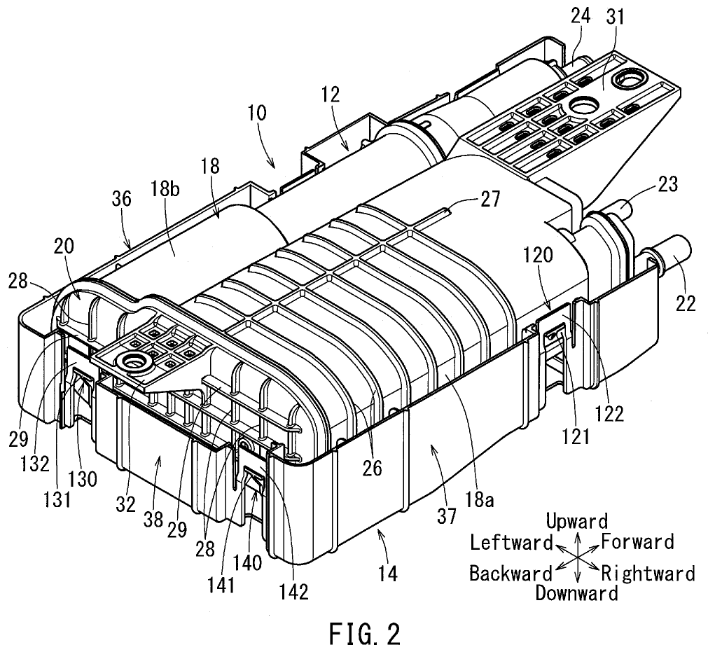

As shown in FIG. 2, the closure plate 20 is connected to the casing body 18 so as to close both of the open rear end of the main casing body 18a and the open rear end of the sub casing body 18b. The casing body 18 is filled with adsorbent (adsorbing materials) that adsorbs and desorbs evaporated fuel (gasoline vapor). Examples of the adsorbent are granular activated carbon or other such materials. Further, the casing body 18 and the closure plate 20 of the canister casing 12 are made of resin. For purposes of clarity and further explanation, the canister casing 12 may be also be referred to herein as a “casing.”

As shown in FIGS. 1-3 and 5, the main casing body 18a includes a plurality of longitudinally-spaced, circumferential ribs 26 that extend circumferentially about an outer circumferential surface thereof. The circumferential ribs 26 extend over an upper (surface) portion, a right side (surface) portion, and a lower (surface) portion of the outer circumferential surface of the main casing body 18a, so as to have a substantially C-shape about a longitudinal axis of the canister casing 12. Further, the circumferential ribs 26 are positioned at predetermined longitudinal intervals and are oriented parallel to each other. Further, the main casing body 18a includes a longitudinal rib 27 that is formed on the outer circumferential surface thereof. The longitudinal rib 27 longitudinally extends along the upper portion of the outer circumferential surface of the main casing body 18a and intersects the circumferential ribs 26 at right angles. Further, the main casing body 18a includes a plurality of supplemental longitudinal ribs (not shown) that are formed on the outer circumferential surface thereof. The supplemental longitudinal ribs longitudinally extend along the lower portion of the outer circumferential surface of the main casing body 18a and intersect with the circumferential ribs 26 at right angles in a lattice-shaped pattern.

As shown in FIG. 2, the closure plate 20 includes a plurality of vertical ribs 28 formed on a rear (outer) surface thereof. The vertical ribs 28 are positioned at predetermined lateral intervals and are oriented parallel to each other. Further, the closure plate 20 includes a plurality of lateral ribs 29 formed on the rear surface thereof. The lateral ribs 29 are positioned at predetermined vertical intervals and intersect the vertical ribs 28 at right angles in a lattice-shaped pattern.

As shown in FIGS. 1-5, the main casing body 18a includes a front bracket 31 formed on an upper edge of the front end surface thereof and projecting forward therefrom. Further, the closure plate 20 includes a rear bracket 32 formed on an upper edge thereof and projecting backward therefrom.

As shown in FIG. 5, the protector 14 is made of resin. The protector 14 includes a bottom wall portion 35, a left side wall portion 36, a right side wall portion 37, a rear wall portion 38, and an auxiliary side wall portion 39. The bottom wall portion 35 is a substantially horizontally oriented, plate-shaped member that functions to cover a lower surface of the canister casing 12. The bottom wall portion 35 preferably has an area (profile) slightly greater than a projected area (profile) of the canister casing 12 as projected from above. As shown in FIG. 4, the bottom wall portion 35 includes a front raised portion 35a and a rear lowered portion 35b that are continuous with each other via a sloped transition portion 35c. The front raised portion 35a has a sloped end portion 35d at a front end portion thereof and gently, obliquely extends upward and forward therefrom. Further, the front raised portion 35a has a plate-shaped elongated portion 35e formed on a left end portion thereof and extending forward therefrom.

As shown in FIG. 5, the left side wall portion 36 is a flat plate-shaped wall portion extending vertically upwards from a left edge of the bottom wall portion 35 and functions to cover a left side surface of the canister casing 12. The right side wall portion 37 is a flat plate-shaped wall portion extending vertically upwards from a right edge of the bottom wall portion 35 and functions to cover a right side surface of the canister casing 12. Further, the rear wall portion 38 is a flat plate-shaped wall portion extending vertically upwards from a rear edge of the bottom wall portion 35 and functions to cover a rear surface of the canister casing 12. Right and left edges of the rear wall portion 38 are integrally connected to a rear edge of the left side wall portion 36 and a rear edge of the right side wall portion 37, respectively. Further, the auxiliary side wall portion 39 is a flat plate-shaped wall portion extending vertically upwards from a right edge of the elongated plate-shaped portion 35e of the bottom wall portion 35 and functions to cover a right side surface of the frontal portion of the sub casing body 18b of the canister casing 12. Each of the wall portions 36, 37, 38, 39 of the protector 14 has a height slightly less than a height of the canister casing 12. However, the height of each of the wall portions 36, 37, 38, 39 may be changed as necessary.

The front raised portion 35a, the rear lowered portion 35b, and the sloped transition portion 35c of the bottom wall portion 35 each includes a plurality of substantially rectangular drainage holes 41 (e.g., three drainage holes 41) penetrating each in a thickness direction. The drainage holes 41 in each portion 35a, 35b, 35c are arranged in a lateral row and spaced at lateral intervals. Also, the elongated portion 35e of the bottom wall portion 35 has a drainage hole 41a similar to the drainage holes 41.

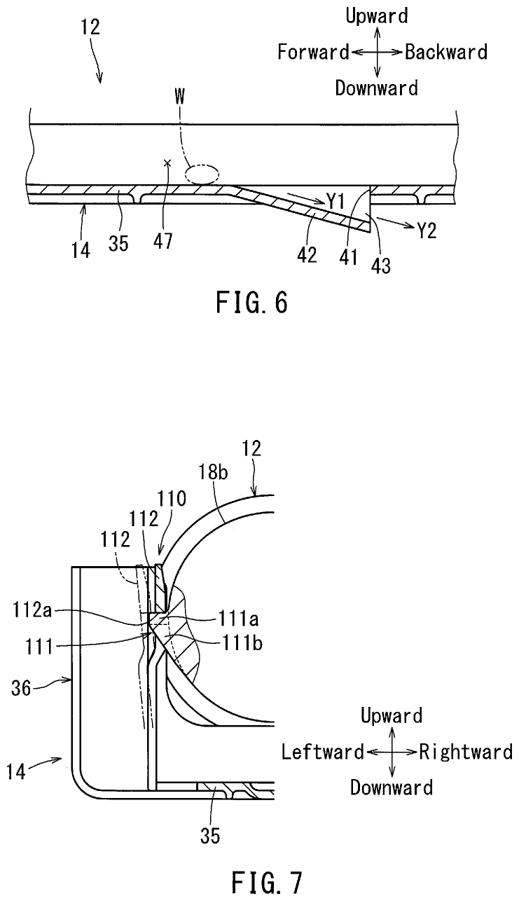

As shown in FIG. 6, the bottom wall portion 35 includes flat plate-shaped cover members 42 formed thereon and substantially covering the drainage holes 41 from below. The cover members 42 extend obliquely backward and downward from front edges of the corresponding drainage holes 41, 41a, so as to define drainage openings 43 that are opened toward the backward direction. Further, side edges of each of the cover members 42 are continuous with the bottom wall portion 35.

As shown in FIG. 5, the protector 14 has four pairs of front and rear, L-shaped retainer ribs 45 that are symmetrically shaped. The front pairs of retainer ribs 45 are positioned on concave corners between the front raised portion 35a of the bottom wall portion 35 and the corresponding right and left side wall portions 36, 37. Conversely, the rear pairs of retainer ribs 45 are positioned on concave corners between the rear lowered portion 35b of the bottom wall portion 35 and the corresponding right and left side wall portions 36, 37.

As shown in FIG. 3, the canister 10 includes a plurality of (first to sixth) snap-fit mechanisms 110, 120, 130, 140, 150, 160 positioned between and coupling the canister casing 12 and the protector 14. The first snap-fit mechanism 110 is positioned on a central portion of a left side of the canister 10. The second snap-fit mechanism 120 is positioned on a front portion of a right side of canister 10. The third snap-fit mechanism 130 is positioned on a left portion of a rear side of the canister 10. The fourth snap-fit mechanism 140 is positioned on a right portion of the rear side of the canister 10. The fifth snap-fit mechanism 150 is positioned on a front portion of the left side of the canister 10. Further, the sixth snap-fit mechanism 160 is positioned on a central portion of a front side of the canister 10.

As shown in FIGS. 1, 5, 7, and 8, the first snap-fit mechanism 110 includes a T-shaped first engagement projection 111 formed on and projecting leftward from a left side of the sub casing body 18b of the canister casing 12, and a slotted gate-shaped first elastic engagement strip 112 formed on the left side wall portion 36 of the protector 14. Further, the first engagement projection 111 includes a horizontal engagement claw 111a and a vertical reinforcement rib 111b extending downward from a central portion of the engagement claw 111a. For purposes of clarity and further explanation, the canister casing 12 and the protector 14 may also be referred to herein as “one member” and “another member.”

As shown in FIGS. 1, 5, and 7, the first engagement strip 112 is shaped such that a substantial (upper) portion thereof is offset inward (rightward). As shown by the double-dashed lines in FIG. 7, the first engagement strip 112 is configured to elastically flex outward (leftward). The first engagement strip 112 has a vertically elongated, rectangular first engagement slot 112a formed thereon. The first engagement strip 112 is configured such that the first engagement slot 112a can engage the first engagement projection 111 via elastic deformation of the first engagement strip 112. In other words, the first engagement strip 112 is configured such that an upper transverse section thereof can engage the horizontal engagement claw 111a of the first engagement projection 111. For purposes of clarity and further explanation, the first engagement projection 111 and the first engagement strip 112 may also be referred to herein as an “engaged portion” and an “engaging portion,” respectively.

As shown in FIGS. 2, 5, 9, and 10, the second snap-fit mechanism 120 includes a T-shaped first engagement projection 121 formed on and projecting rightward from a right side of the main casing body 18a of the canister casing 12, and a slotted gate-shaped second elastic engagement strip 122 formed on the right side wall portion 37 of the protector 14. The second engagement projection 121 includes a horizontal engagement claw 121a and a vertical reinforcement rib 121b extending downward from a central portion of the engagement claw 121a. Further, the second engagement projection 121 is connected to the main casing body 18a via a base member 123 formed on a proximal end thereof

As shown in FIGS. 2, 5, and 9, the second engagement strip 122 is shaped such that a substantial (upper) portion thereof is offset inward (leftward). As shown by the double-dashed lines in FIG. 9, the second engagement strip 122 is configured to elastically flex outward (rightward). The second engagement strip 122 has a vertically elongated rectangular second engagement slot 122a formed thereon. The second engagement strip 122 is configured such that the second engagement slot 122a can engage the second engagement projection 121 via the elastic deformation of the second engagement strip 122. In other words, the second engagement strip 112 is configured such that an upper transverse section thereof can engage the horizontal engagement claw 121a of the second engagement projection 121. For purposes of clarity and further explanation, the second engagement projection 121 and the second engagement strip 122 may also be referred to herein as the “engaged portion” and the “engaging portion,” respectively.

As shown in FIGS. 2, 5, 11, and 12, the third snap-fit mechanism 130 includes a T-shaped third engagement projection 131 formed on and projected backward from the rear surface of the closure plate 20, and a slotted gate-shaped third elastic engagement strip 132 formed on the rear wall portion 38 of the protector 14. The third engagement projection 131 includes a horizontal engagement claw 131a and a vertical reinforcement rib 131b extending downward from a central portion of the engagement claw 131a. As shown in FIG. 12, the engagement claw 131a is integrated with the lateral ribs 29 formed on the rear surface of the closure plate 20. The reinforcement rib 131b is integrated with the vertical ribs 28 formed on the rear surface of the closure plate 20.

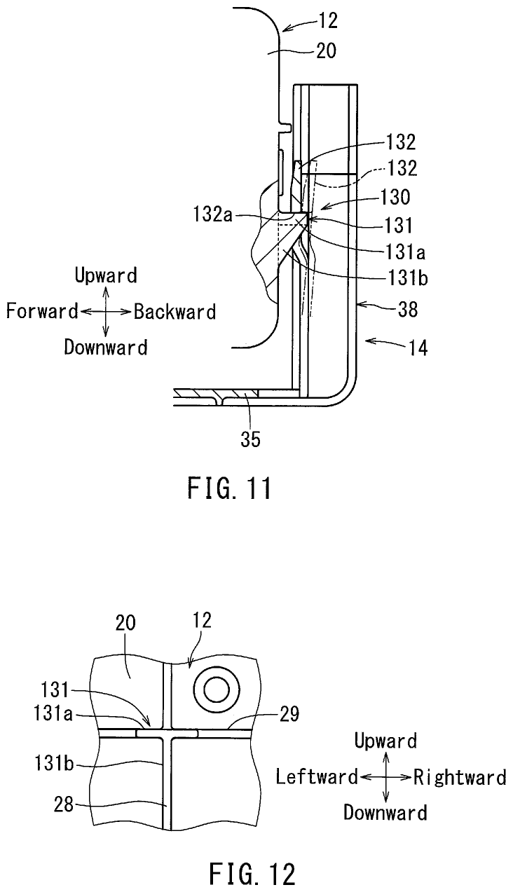

As shown in FIGS. 2, 5, and 11, the third engagement strip 132 is shaped such that a substantial (upper) portion thereof is offset inward (forward). As shown by the double-dashed lines in FIG. 11, the third engagement strip 132 is configured to elastically flex outward (backward). The third engagement strip 132 has a vertically elongated rectangular third engagement slot 132a formed thereon. The third engagement strip 132 is configured such that the third engagement slot 132a can engage the third engagement projection 131 via elastic deformation of the third engagement strip 132. In other words, the third engagement strip 132 is configured such that an upper transverse section thereof can engage the horizontal engagement claw 131a of the third engagement projection 131. For purposes of clarity and further explanation, the third engagement projection 131 and the third engagement strip 132 may also be referred to herein as the “engaged portion” and the “engaging portion,” respectively.

As shown in FIGS. 2, 5, 13, and 14, the fourth snap-fit mechanism 140 includes a T-shaped fourth engagement projection 141 formed on and projected backward from the rear surface of the closure plate 20, and a slotted gate-shaped fourth elastic engagement strip 142 formed on the rear wall portion 38 of the protector 14. The fourth engagement projection 141 includes a horizontal engagement claw 141a and a vertical reinforcement rib 141b extending downward from a central portion of the engagement claw 141a. As shown in FIG. 14, the engagement claw 141a is integrated with the lateral ribs 29 formed on the rear surface of the closure plate 20. The reinforcement rib 141b is integrated with the vertical ribs 28 formed on the rear surface of the closure plate 20.

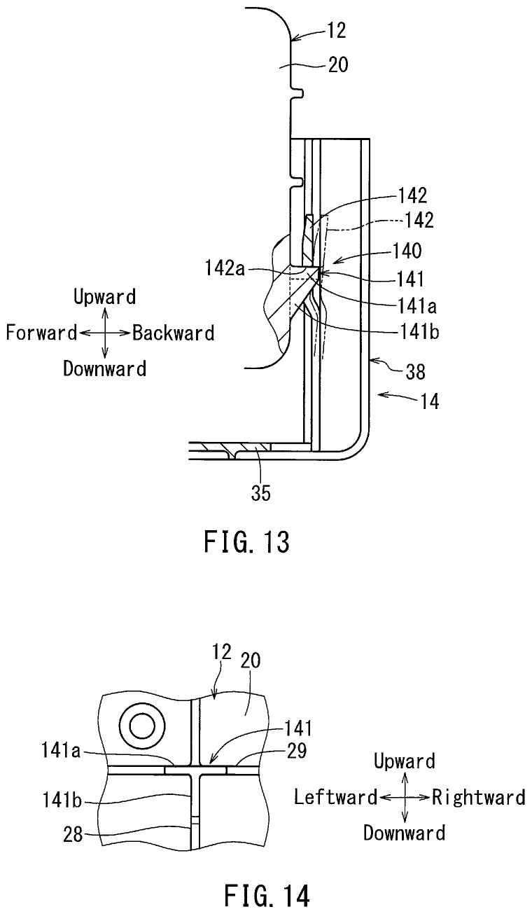

As shown in FIGS. 2, 5, and 13, the fourth engagement strip 142 is shaped such that a substantial (upper) portion thereof is offset inward (forward). As shown by the double-dashed lines in FIG. 13, the fourth engagement strip 142 is configured to elastically flex outward (backward). The fourth engagement strip 142 has a vertically elongated rectangular fourth engagement slot 142a formed thereon. The fourth engagement strip 142 is configured such that the fourth engagement slot 142a can engage the fourth engagement projection 141 via elastic deformation of the fourth engagement strip 142. In other words, the fourth engagement strip 142 is configured such that an upper transverse section thereof can engage the horizontal engagement claw 141a of the fourth engagement projection 141. For purposes of clarity and further explanation, the fourth engagement projection 141 and the fourth engagement strip 142 may also referred to herein as the “engaged portion” and the “engaging portion,” respectively.

As shown in FIGS. 1, 5, 15, and 16, the fifth snap-fit mechanism 150 includes a fifth engagement projection 151 formed on and projected leftward from the left side of the sub casing body 18b of the canister casing 12, and a slotted gate-shaped fifth elastic engagement strip 152 formed on the left side wall portion 36 of the protector 14. Further, the fifth engagement projection 151 is formed as a horizontally extending linear rib-shaped member.

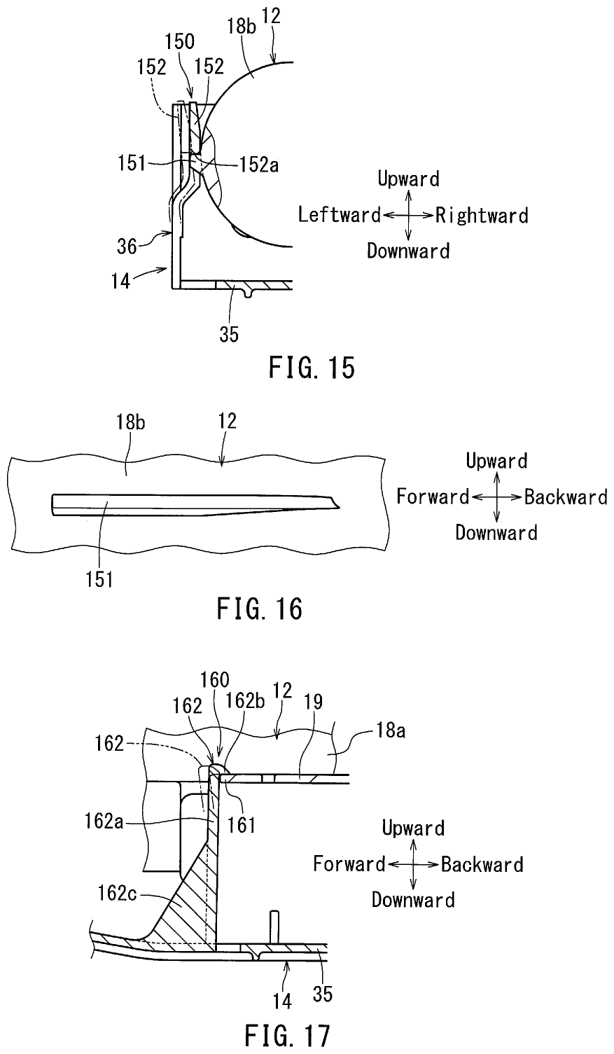

As shown by the double-dashed lines in FIG. 15, the fifth engagement strip 152 is configured to elastically flex outward (leftward). The fifth engagement strip 152 has a vertically elongated rectangular fifth engagement slot 152a formed thereon. The fifth engagement strip 152 is configured such that the fifth engagement slot 152a can engage the fifth engagement projection 151 via elastic deformation of the fifth engagement strip 152. In other words, the fifth engagement strip 152 is configured such that an upper transverse section thereof can engage the fifth engagement projection 151. However, the fifth engagement strip 152 is configured such that the upper transverse section thereof can engage only a portion (front portion) of the fifth engagement projection 151. That is, the fifth engagement strip 152 is configured such that a front vertical section thereof can contact or face a front end surface of the fifth engagement projection 151 while a substantial (upper) portion of a rear vertical section thereof may be offset inward (rightward) so as to hang over the fifth engagement projection 151. For purposes of clarity and further explanation, the fifth engagement projection 151 and the fifth engagement strip 152 may also be referred to herein as the “engaged portion” and the “engaging portion,” respectively.

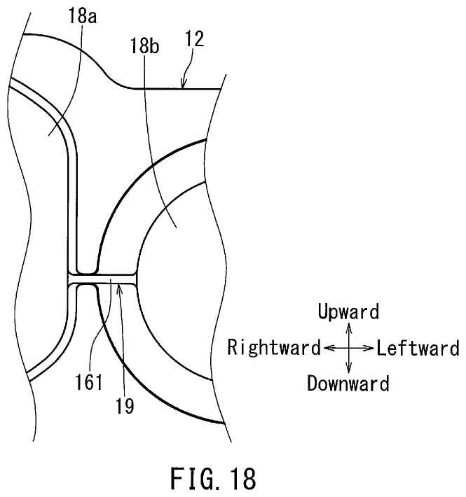

As shown in FIGS. 1, 5, 17, and 18, the sixth snap-fit mechanism 160 includes a sixth engagement projection 161 formed on the connecting member 19 of the canister casing 12, and a sixth elastic engagement strip 162 formed on the bottom wall portion 35 of the protector 14. Further, as shown in FIGS. 17 and 18, the sixth engagement projection 161 is defined by a front end portion of the connecting member 19 of the canister casing 12.

The sixth elastic engagement strip 162 has a plate-shaped upright strip portion 162a extending vertically from the bottom wall portion 35. The upright strip portion 162a is positioned such that front and rear surfaces thereof are directed in longitudinal directions. Further, the sixth elastic engagement strip 162 has an engagement hook or claw 162b formed on and extending along a widthwise upper edge of the upright strip portion 162a and directed backward. Further, the sixth engagement strip 162 has a vertical retainer rib 162c formed on the front surface of the upright strip portion 162a to reinforce the upright strip portion 162a. As shown by the double-dashed lines in FIG. 17, the upright strip portion 162a is configured such that an upper substantial portion thereof can elastically flex forward. The sixth engagement strip 162 is configured such that the engagement claw 162b can engage the sixth engagement projection 161 via elastic deformation of the upper substantial portion of the upright strip portion 162a. For purposes of clarity and further explanation, the sixth engagement projection 161 and the sixth engagement strip 162 may also be referred to herein as the “engaged portion” and the “engaging portion,” respectively.

To attach or connect the canister casing 12 to the protector 14, as shown in FIG. 5, first, the canister casing 12 is horizontally positioned above the protector 14 in vertical alignment with each other. Thereafter, the canister casing 12 is pressed down against the protector 14. As a result, in the first snap-fit mechanism 110, the first engagement projection 111 contacts the first elastic engagement strip 112. Subsequently, the first engagement projection 111 moves downward along the first elastic engagement strip 112 while elastically flexing the first elastic engagement strip 112 outward (leftward). When the first engagement projection 111 clears the upper transverse section of the first elastic engagement strip 112, the first elastic engagement strip 112 is simultaneously elastically restored, so that the first engagement slot 112a of the first elastic engagement strip 112 engages the horizontal engagement claw 111a of the first engagement projection 111 (FIG. 7).

Further, in the second snap-fit mechanism 120, the second engagement projection 121 contacts the second elastic engagement strip 122. Subsequently, the second engagement projection 121 moves downward along the second elastic engagement strip 122 while elastically flexing the second elastic engagement strip 122 outward (rightward). When the second engagement projection 121 clears the upper transverse section of the second elastic engagement strip 122, the second elastic engagement strip 122 is simultaneously elastically restored, so that the second engagement slot 122a of the second elastic engagement strip 122 engages the horizontal engagement claw 121a of the second engagement projection 121 (FIG. 9).

Further, in the third snap-fit mechanism 130, the third engagement projection 131 contacts the third elastic engagement strip 132. Subsequently, the third engagement projection 131 moves downward along the third elastic engagement strip 132 while elastically flexing the third elastic engagement strip 132 outward (backward). When the third engagement projection 131 clears the upper transverse section of the third elastic engagement strip 132, the third elastic engagement strip 132 is simultaneously elastically restored, so that the third engagement slot 132a of the third elastic engagement strip 132 engages the horizontal engagement claw 131a of the third engagement projection 131 (FIG. 11).

Further, in the fourth snap-fit mechanism 140, the fourth engagement projection 141 contacts the fourth elastic engagement strip 142. Subsequently, the fourth engagement projection 141 moves downward along the fourth elastic engagement strip 142 while elastically flexing the fourth elastic engagement strip 142 outward (backward). When the fourth engagement projection 141 clears the upper transverse section of the fourth elastic engagement strip 142, the fourth elastic engagement strip 142 is simultaneously elastically restored, so that the fourth engagement slot 142a of the fourth elastic engagement strip 142 engages the horizontal engagement claw 141a of the fourth engagement projection 141 (FIG. 13).

Further, in the fifth snap-fit mechanism 150, the fifth engagement projection 151 contacts the fifth elastic engagement strip 152. Subsequently, the fifth engagement projection 151 moves downward along the fifth elastic engagement strip 152 while elastically flexing the fifth elastic engagement strip 152 outward (leftward). When the fifth engagement projection 151 clears the upper transverse section of the fifth elastic engagement strip 152, the fifth elastic engagement strip 152 is simultaneously elastically restored, so that the fifth engagement slot 152a of the fifth elastic engagement strip 152 engages the front portion of the fifth engagement projection 151 (FIG. 15).

Further, in the sixth snap-fit mechanism 160, the sixth engagement projection 161 contacts the engagement claw 162b of the sixth engagement strip 162. Subsequently, the sixth engagement projection 161 moves downward along the engagement claw 162b while elastically flexing the upright strip portion 162a outward (forward). When the sixth engagement projection 161 clears the engagement claw 162b, the upright strip portion 162a is simultaneously elastically restored, so that the engagement claw 162b engages the sixth engagement projection 161 (FIG. 17).

In the manner described, the canister casing 12 is attached to the protector 14 via the first to sixth snap-fit mechanisms 110, 120, 130, 140, 150, 160. As a result, the canister casing 12 is attached to the protector 14 in a condition in which the canister casing 12 is reliably positioned relative to the protector 14 in the longitudinal and lateral directions, and in which the canister casing 12 is securely retained in the protector 14 (FIGS. 1 to 3) with a lower side of the canister casing 12 covered by the protector 14. In particular, the lower surface, the left side surface, the right side surface, and the rear surface of the canister casing 12, as well as the right and left side surfaces of the frontal portion of the sub casing body 18b of the canister casing 12, are covered by the protector 14.

The canister casing 12 is stably supported by the plurality of retainer ribs 45 of the protector 14 in a condition in which the canister casing 12 is reliably positioned in the lateral directions. Further, due to the retainer ribs 45, a clearance 47 is formed between the canister casing 12 and the protector 14 (FIG. 4). The clearance 47 extends continuously in the longitudinal and lateral directions.

To attach the canister casing 12 provided with the protector 14 to the vehicle, the canister case 12 is positioned on the lower surface portion of the vehicle. Thereafter, as shown in FIG. 4, the front bracket 31 and the rear bracket 32 on the canister casing 12 are fixed to the lower side of the floor panel 16 of the vehicle body by mounting bolts 50. Thus, the canister casing 12 is attached to the lower surface portion of the vehicle, i.e., the lower side of the floor panel 16 of the vehicle body, via a double supporting structure. Further, the number of the mounting bolts 50 is not limited.

After the canister casing 12 is attached to the vehicle, the tank port 22 is connected to a fuel tank (not shown) via a piping member (not shown). In addition, the purge port 23 (FIG. 3) is connected to an intake duct (not shown) of a vehicle engine (internal combustion engine) via a piping member (not shown). Further, the atmosphere port 24 (FIG. 3) is open to the atmosphere.

In the canister 10, because the lower side of the canister casing 12 is covered by the protector 14, the canister casing 12 may be protected from pebbles and mud water tossed up while the vehicle is running.

Further, because the clearance 47 is formed between the canister casing 12 and the protector 14, a flow of air flowing from before backward can be formed between the canister casing 12 and the protector 14 while the vehicle is running (FIG. 4).

Further, even when water W enters the clearance 47 between the canister casing 12 and the protector 14, the water W can flow into the drainage holes 41, 41a formed on the bottom wall portion 35 of the protector 14 (shown by an arrow Y1 in FIG. 6). The water W entered the drainage holes 41, 41a flows along the cover members 42 and is then discharged via the drainage openings 43 (shown by an arrow Y2 in FIG. 6). Negative pressures may be produced around the drainage openings 43 due to the flow of air flowing through the clearance 47 and a flow of air flowing along an outer surface of the bottom wall portion 35. Therefore, the water W can be smoothly and quickly discharged via the drainage openings 43.

According to the embodiment, when the canister casing 12 and the protector 14 are moved relatively to each other in one direction, i.e., in a vertical direction, the first to sixth engagement projections 111, 121, 131, 141, 151, 161 and the first to sixth elastic engagement strips 112, 122, 132, 142, 152, 62 of the first to sixth snap-fit mechanisms 110, 120, 130, 140, 150, 160, respectively, can engage with each other due to the elastic deformation of the first to sixth elastic engagement strips 112, 122, 132, 142, 152, 162. Therefore, the canister casing 12 and the protector 14 can be easily connected to each other. Further, because the canister casing 12 and the protector 14 are connected to or integrated with each other using the first to sixth snap-fit mechanisms 110, 120, 130, 140, 150, 160, various threaded parts can be omitted. This may lead to a reduction of parts. As a result, workability and assembly of connecting operation of the canister casing 12 and the protector 14 can be increased and simplified.

Further, the protector 14 is made of resin. This may lead to a lightening and a reduction of cost of the protector 14 compared with a metal protector. Further, air can flow through the clearance 47 while the vehicle is running. This may prevent heat from being accumulated between the canister casing 12 and the protector 14.

Further, the bottom wall portion 35 of the protector 14 have the drainage holes 41, 41a formed thereon. Therefore, even when water W enters the protector 14, the water W can be discharged via the drainage openings 43 of the drainage holes 41, 41a.

Further, the bottom wall portion 35 of the protector 14 has the cover members 42 substantially covering the drainage holes 41, 41a from below and configured to guide the water W introduced into the drainage holes 41 toward the drainage openings 43 that are opened backward. Therefore, the pebbles and the mud water tossed up while the vehicle is running may be prevented from entering the protector 14 via the drainage holes 41 and 41a.

Further, the water W introduced into the clearance 47 flows into the drainage holes 41, 41a. Thereafter, the water W is discharged via the drainage openings 43. Further, the water W can be smoothly and quickly discharged via the drainage openings 43 due to the negative pressures caused by the flow of air.

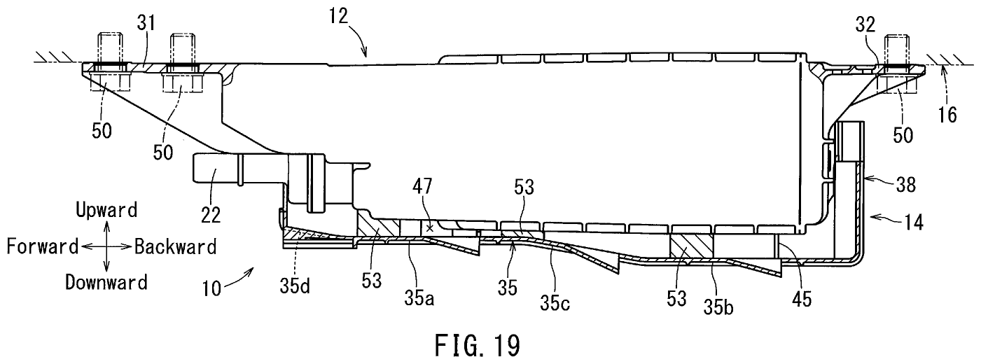

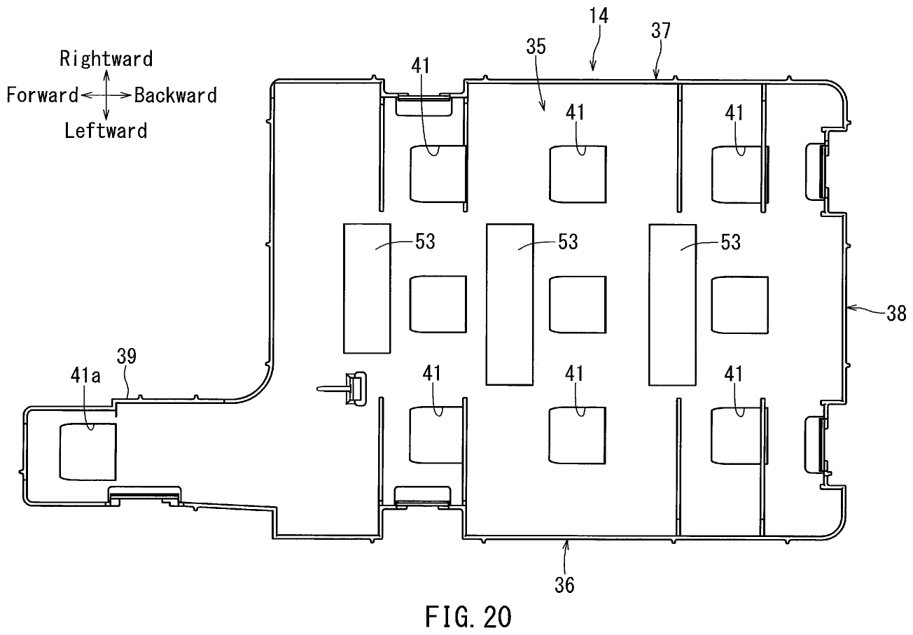

Referring now to FIGS. 19 and 20, a second embodiment of the present disclosure is shown and will now be described.

Because the second embodiment relates to the first embodiment, only the constructions and elements that are different from the first embodiment will be explained in detail. In particular, this embodiment is different from the first embodiment in that a plurality of cushioning members 53 are used.

As shown in FIG. 20, in the second embodiment, the plurality of cushioning members 53 (three in this embodiment) are attached to the bottom wall portion 35 of the protector 14 by adhesion or other such methods. The cushioning members 53 are made of elastic resin materials such as urethane foam and foamed rubber. The cushioning members 53 have a laterally elongated plate shape and a predetermined thickness (height). The cushioning members 53 are positioned in front of the respective rows of drainage holes 41. Further, the cushioning members 53 are positioned along a longitudinal axis of the protector 14.

As shown in FIG. 19, when the canister casing 12 is attached to the protector 14, the cushioning members 53 are sandwiched and elastically compressed between the canister casing 12 and the protector 14.

According to the second embodiment, the canister casing 12 can be attached to the protector 14 without producing looseness or backlash therebetween. Therefore, the canister 10 can be prevented from generating noise while the vehicle is running.

Naturally, various changes and modifications may be made to the canister 10 of the first and second embodiments. For example, in the embodiments, the canister casing 12 and the protector 14 are configured to be connected to each other when the canister casing 12 and the protector 14 move in the vertical direction relative to each other. However, the canister casing 12 and the protector 14 may be configured to be connected to each other while allowing relative movement therebetween in the lateral direction and/or the longitudinal direction. In addition, the number of the snap-fit mechanisms may preferably changed as necessary. Further, in the embodiments, the engaged portion and the engaging portion of each of the snap-fit mechanisms are formed on the canister casing 12 and the protector 14, respectively. However, the engaged portion and the engaging portion of at least one of the snap-fit mechanisms may alternatively be formed on the protector 14 and the canister casing 12, respectively. Further, the cover members 42 formed on the bottom wall portion 35 may be omitted as necessary.

Representative examples of the present disclosure have been described in detail with reference to the attached drawings. This detailed description is merely intended to teach a person of skill in the art further details for practicing preferred aspects of the present disclosure and is not intended to limit the scope of the disclosure. Only the claims define the scope of the claimed disclosure. Therefore, combinations of features and steps disclosed in the foregoing detail description may not be necessary to practice the disclosure in the broadest sense, and are instead taught merely to particularly describe detailed representative examples of the disclosure. Moreover, the various features taught in this specification may be combined in ways that are not specifically enumerated in order to obtain additional useful embodiments of the present disclosure.

What is claimed is:

1. An evaporated fuel processing device configured to be attached to a lower surface portion of a vehicle and process evaporated fuel generated in a fuel tank of the vehicle, the evaporated fuel processing device comprising:
a casing filled with adsorbent configured to adsorb and desorb the evaporated fuel; and
a protector covering a lower side the casing;
wherein the casing and the protector are coupled to each other via a plurality of snap-fit mechanisms,
wherein each snap-fit mechanism includes an engaged portion formed on one of the casing and the protector, and an engaging portion formed on another of the casing and the protector, wherein engaging portion of each snap-fit mechanism is configured to engage the corresponding engaged portion via elastic deformation thereof; and
wherein the engaging portions and the engaged portions are configured to engage each other when the casing and the protector move relative to each other in one direction.

2. The evaporated fuel processing device of claim 1, wherein the protector includes a substantially horizontal bottom wall portion, and wherein the bottom wall portion includes a plurality of drainage holes extending therethrough in a vertical direction.

3. The evaporated fuel processing device of claim 2, wherein the bottom wall portion includes a plurality of cover members, wherein each cover member covers one of the drainage holes from below and is configured to guide water introduced into the corresponding drainage hole toward a corresponding drainage opening that is opened backward.

4. The evaporated fuel processing device of claim 1, further comprising a plurality of cushioning members interleaved between the casing and the protector.
